(19) United States
(12) Patent Application Publication
(10) Pub. No.: US 2026/0082245 A1
(43) Pub. Date: Mar. 19, 2026

(54) SUBSCRIBER BASED ISSUE ISOLATION ON A 5G STANDALONE COMMUNICATION NETWORK

(71) Applicant: DISH Wireless L.L.C., Englewood, CO (US)

(72) Inventors: Abhishek Jayprakash Shirke, Aurora, CO (US); Jaya Chandra Chikatmarla, Highlands Ranch, CO (US); Kameswara Achyuth Kumar Kala, Highlands Ranch, CO (US); MythriAmulya Sabhapati, Highlands Ranch, CO (US); ShashiKiran Sureshbabu, Highlands Ranch, CO (US); Ravi Madhavan, Naperville, IL (US); Prakash Patel, Castle Rock, CO (US); Mohammad Dawood Shahdad, Aurora, CO (US)

(21) Appl. No.: 18/886,617

(22) Filed: Sep. 16, 2024

(51) Int. Cl. H04W 24/04; H04W 76/25

(52) U.S. Cl. CPC H04W 24/04; H04W 76/25

(57) ABSTRACT

A system for performing subscriber-based issue isolation in a communication network includes a processing database comprising subscriber call data associated with a plurality of user equipment devices in the communication network, a user interface configured to receive a subscriber identifier associated with a user equipment device of the plurality of user equipment devices having a reported problem with a communication session over the communication network, a standardized call flow database comprising a set of predefined standardized call flows for the communication network, and an issue isolation module configured to identify at least one network function in the communication network associated with the reported problem by comparing subscriber call data associated with the subscriber identifier to the set of predefined standardized call flows, and to remove the identified at least one network function out of rotation in the communication network.

### BACKGROUND

Wireless communication networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers and other devices. 5G technologies are capable of supplying much greater bandwidths than was previously available.

### SUMMARY

In accordance with an embodiment, a system for performing subscriber-based issue isolation in a communication network includes a processing database comprising subscriber call data associated with a plurality of user equipment devices in the communication network, a user interface configured to receive a subscriber identifier associated with a user equipment device of the plurality of user equipment devices having a reported problem with a communication session over the communication network, a standardized call flow database comprising a set of predefined standardized call flows for the communication network and an issue isolation module coupled to an in communication with the processing database, the user interface, and the standardized call flow database. The issue isolation module is configured to identify at least one network function in the communication network associated with the reported problem by comparing subscriber call data associated with the subscriber identifier to the set of predefined standardized call flows, and to remove the identified at least one network function out of rotation in the communication network.

In accordance wither another embodiment, a method for performing subscriber-based issue isolation in a communication network having a plurality of user equipment devices includes receiving a subscriber identifier associated with a user equipment device of the plurality of user equipment devices having a reported problem with a communication session over the communication network. retrieving, using an issue isolation module, subscriber call data associated with the subscriber identifier, comparing, using the issue isolation module, the subscriber call data to a set of predefined standardized call flows for the communication network, identifying, using the issue isolation module, at least one network function in the communication network associated with the reported problem, and removing, using the issue isolation module, the identified at least one network function out of rotation in the communication network.

In accordance with another embodiment, a non-transitory, computer-readable medium storing instructions that, when executed by an electronic processor, perform a set of functions for performing subscriber-based issue isolation in a communication network. The set of functions includes receiving a subscriber identifier associated with a user equipment device having a reported problem with a communication session over the communication network, retrieving subscriber call data associated with the subscriber identifier, comparing the subscriber call data to a set of predefined standardized call flows for the communication network, identifying at least one network function in the communication network associated with the reported problem; and removing the identified at least one network function out of rotation in the communication network.

### BRIEF DESCRIPTION OF THE DRAWINGS

The present disclosure will hereafter be described with reference to the accompanying drawings, wherein like reference numerals denote like elements.

FIG. 1 is a schematic block diagram of an example communication network in accordance with an embodiment;

FIG. 2 is a schematic block diagram of an example of a service-based architecture of a communication network in accordance with an embodiment;

FIG. 3 is a schematic diagram of an example region-based network topology for a communication network in accordance with an embodiment;

FIG. 4 is a schematic block diagram of a system for performing subscriber-based issue isolation in a communication network;

FIG. 5 illustrates a method for performing subscriber-based issue isolation in a communication network in accordance with an embodiment; and

FIG. 6 is a schematic block diagram of an example computer system in accordance with an embodiment.

### DETAILED DESCRIPTION

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computer device or can be distributed among different computing devices connected by one or more networks or other suitable communication links.

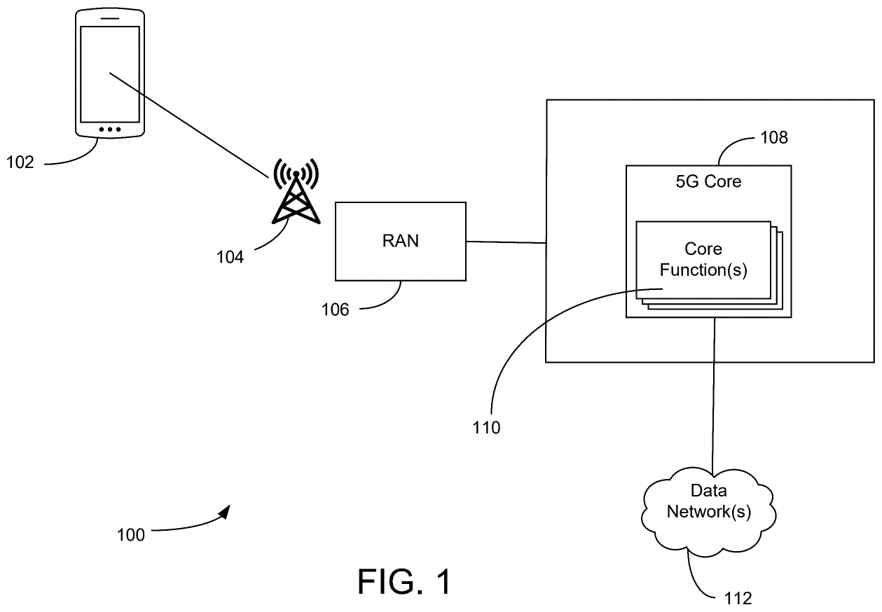

FIG. 1 is a schematic block diagram of an example communication network in accordance with an embodiment. The communication network 100 can include a user equipment (UE) device 102, a radio access network (RAN) 106, and a 5G core 108. The RAN 106 and 5G core 108 can enable the UE device 102 to, for example, communicate with other UE devices and to communicate with one or more external data networks (DNs) 112 (e.g., the Internet or a private corporate network) using the RAN 106 and 5G core 108. For example, if the external data network 112 is the Internet, the RAN 106 and 5G core 108 can allow the UE device 102 to send and receive data via the Internet. While FIG. 1 illustrates various components of communication network 100, other embodiments of communication network 100 can vary the arrangement, communication paths, and specific components of communication network 100. In some embodiments, the wireless communication network 100 can include fewer, additional, or different components in different configurations than illustrated in FIG. 1. For example, in some embodiments, the wireless communication network 100 may include additional or different UE devices 102.

The communication network 100 may be used to facilitate multiple types of communication sessions, such as, for example, voice calls, video calls, messaging, data transmission, and/or other types of communications. The communication network 100 may represent a portion of a wireless network built around 5G (fifth generation) standards promulgated by standards setting organizations under the umbrella of the Third Generation Partnership Project (3GPP). Accordingly, in some configurations, the communication network 100 may be a 5G network, such as, for example, a 5G cellular network. Such 5G networks, including the communication network 100, may comply with industry standards, such as, for example, the Open Radio Access Network (Open RAN or O-RAN) standard that describes interactions between the network and user equipment (e.g., mobile phones and the like). The O-RAN model follows a virtualized model for a 5G wireless architecture in which 5G base stations (gNBs) are implemented using separate centralized units (CUs), distributed units (DUs), and radio units (RUs). In some configurations, O-RAN CUs and DUs may be implemented using software modules executed by distributed (e.g., cloud) computing hardware.

In some configurations, the communication network 100 may be a standalone (SA) network (e.g., a 5G SA network) that utilizes 5G cells for both signaling and information transfer via a 5G packet core architecture. In other configurations, the communication network 100 may be a non-standalone (NSA) network that depends on another network, such as, for example, a control plane of a fourth generation (4G) long-term evolution (LTE) network.

As mentioned, in some embodiments, the UE device 102 can transmit data from one or more applications on the UE device 102 to an external data network (DN) 112, for example, the Internet, via the communication network 100. While FIG. 1 illustrates one UE device 102, in some embodiments, it should be understood that the communication network 100 can support a plurality of UE devices 102. UE device 102 can be various forms of wireless devices that are capable of communication according to the radio access technology (RAT) of the communication network 100 (e.g., a 5G new radio (NR) network). For example, in some embodiments, the UE device 102 can be a smartphone, a wireless modem, a cellular phone, a laptop computer, a wireless access point (AP), etc.

After the UE device 102 has established a connection or session with the RAN 106, the communication network 100 can provide data (e.g., data packets) to the UE device 102 and can receive data from the UE device 102. In some embodiments, the data can include, for example, voice data for a phone call, data provided by a web server to the UE device 102, data provided by the UE device 102 to a Web server, or other types of data commonly exchanged on communication networks. For example, after the UE device 102 has established a connection or session with the RAN 106, a user of the UE device 102 may select to stream a video on an application of the UE device 102 via the Internet (e.g., data network 112). The video stream can be provided to the UE device 102 on data packets.

The UE device 102 can communicate with the RAN 106 in various ways, such as, for example, via a radio transceiver 104, which may also be referred to as a radio unit (RU) in the O-RAN architecture. The RAN 106 may be or include a disaggregated RAN (referred to as an Open RAN or O-RAN) which can include hierarchy (e.g., tree structure) of RAN functions. In such examples, the RAN 106 may include one or more CUs and one or more DUs. For example, each of multiple CUs may be coupled with multiple DU, and each DU may be coupled with multiple RUs (e.g., the radio transceiver 104). As such, each UE device 102 can communicate with backhaul network infrastructure (e.g., a 5G Core 108) according to an assigned communication path through a particular RU, DU, and CU. An RU (e.g., the radio transceiver 104) in combination with a DU and CU may be referred to as a gNodeB (gNB) in the O-RAN architecture. Such a gNB may be a 3GPP 5G next generation base station that supports communications with the with the UE device 102.

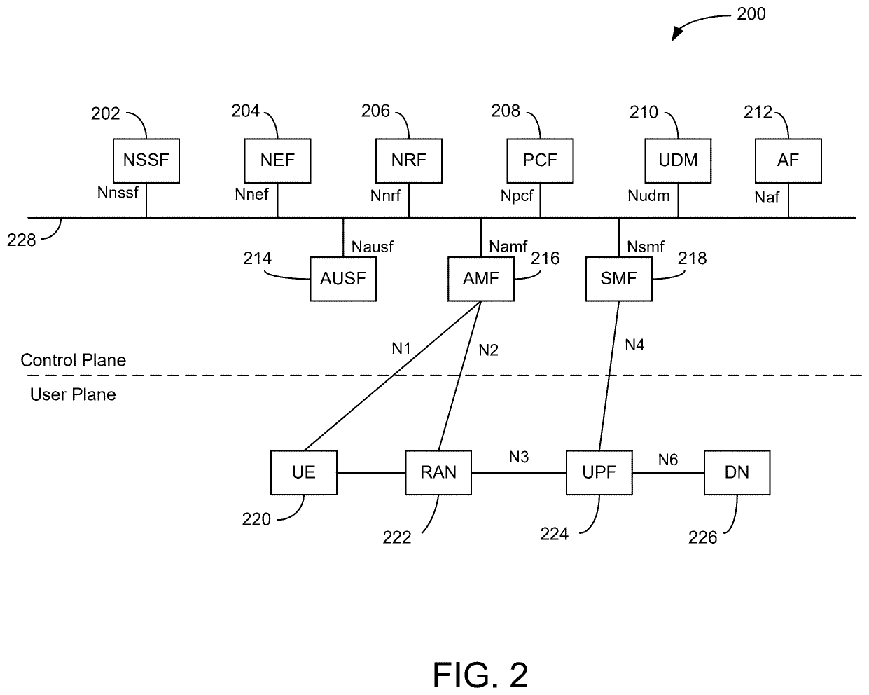

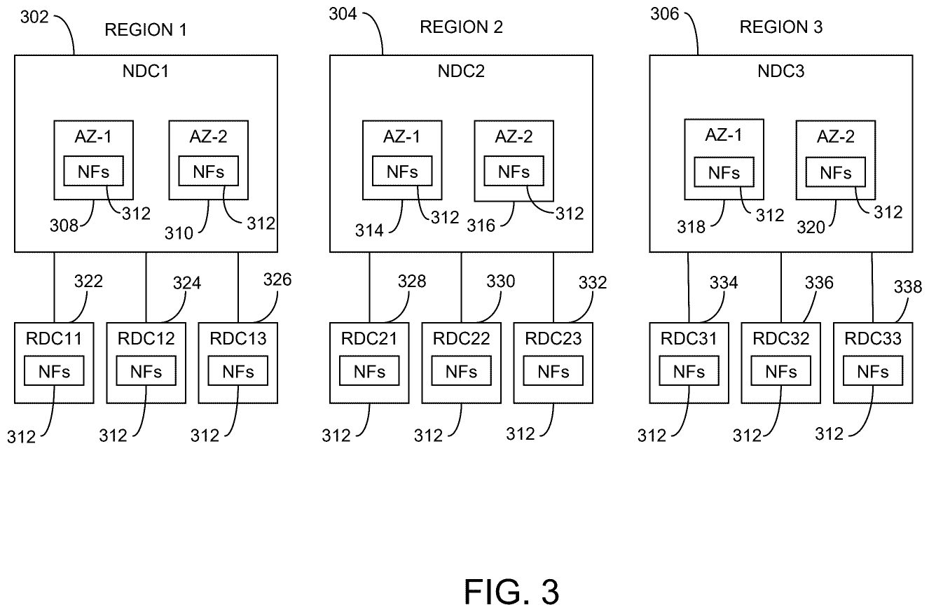

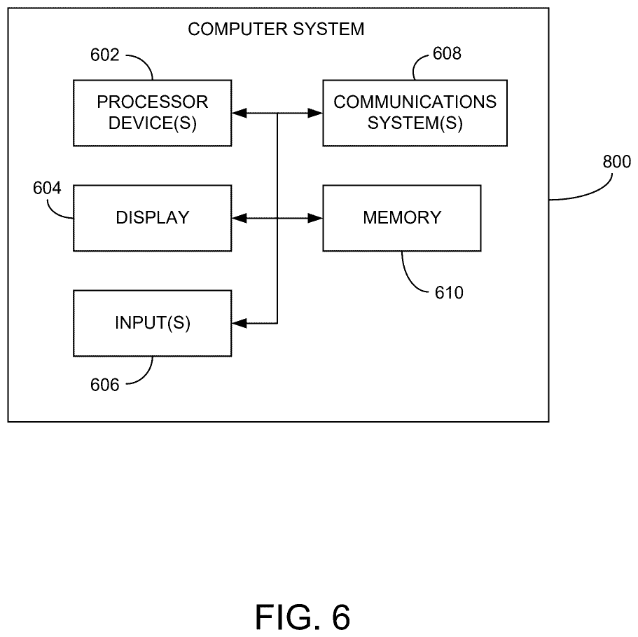

The 5G Core 108 may include one or more core functions 110. Each core function 110 can be a network function (NF) that provides a utility or service specific to the 5G core 108, for example, core functions of the communication network 100. In some embodiments, for example, different NFs may provide different utility to the communication network 100. In some embodiments, the 5G core 108 including the core functions 110 can reside on a cloud computing platform. For example, in some embodiments, the communication network (e.g., communication network 100), or portion thereof, in which the 5G core 108 is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). Examples of various core functions 110 are discussed further below with respect to FIG. 2. In some embodiments, the RAN 106 and the 5G core 108 (including core functions 110) may be implemented on a computer system (e.g., computer system 600 discussed below with respect to FIG. 6) such as a server or the functionality of the RAN 106, the 5G core 109 and core functions 110 may be distributed among multiple servers or devices (e.g., as part of a cloud service or cloud-computing environment). In some embodiments, the 5G core 108 can be physically distributed across data centers or located at a central national data center (NDC) (e.g., the 5G core can logically reside as part of an NDC, for example, in a region-based network topology which is described further below with respect to FIG. 3). Within an NDC, multiple regional data centers (RDCs) can be logically present. In some embodiments, each of such one or more regional data centers may execute core functions 110 for a different geographic region or a group of RAN components.

FIG. 2 is a schematic block diagram of an example of a service-based architecture (SBA) of a communication network in accordance with an embodiment. The SBA 200 is divided between a control plane and a user plane. The control plane includes a plurality of network functions (NFs) 202-218. The user plane includes a UE 220 (e.g., UE 102 shown in FIG. 1) in communication with a RAN 222, and NFs (e.g., UPF 224). In FIG. 2, the SBA 200 can be used for providing communication between the UE device 220 and a data network 226 (e.g., the Internet). In FIG. 2, the example 5G core is simplified to show some key components, however, implementations can involve additional components. In some embodiments, the communication network (e.g., communication network 100 shown in FIG. 1), or portion thereof, in which the 5G core is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). For ease of illustration, FIG. 2 only shows a single UE 220 being connected to the RAN 222, however, in practical implementations any number of UEs 220 can be present, limited only by the capacity of the network.

In the example architecture illustrated in FIG. 2, the NFs can include a Network Slice Selection Function (NSSF) 202, a Network Exposure Function (NEF) 204, a Network Repository Function (NRF) 206, a policy control function (PCF) 208, a Unified Data Management (UDM) function 210, an Application Function (AF) 212, an Authentication Server Function (AUSF) 214, an Access and Mobility Management Function (AMF) 216, a Session Management Function (SMF) 218, and a User Plane Function (UPF) 224. The NSSF 202 can provide tailor made logical networks on the physical network, for example, the NSSF can be used by the AMF 216 to assist with the selection of a network slice that will serve a particular UE device. The NEF 204 can expose services and resources over application programming interfaces (APIs) within and outside the 5G core. The NRF 206 can enable 5G network functions (NFs) to register and discover each other via a standards-based application programming interface (API). The PCF 208 can apply session policies for the UE device 220, or other devices, when connecting over, for example, 5G. The UDM 210 can manage network user data in a single, centralized element and can allow for generation of authentication vectors, user identification handling, NF registration management, and retrieval of UE device individual subscription data for slice selection. The AF 212 can interact with the 3GPP Core Network in order to provide services, for example, to support one or more of application function influence on traffic routing, application function influence on service function chaining, accessing the NRF 206, interacting with the PCF 208, time synchronization service, IP multimedia subsystem (IMS) interactions with the 5GC, or packet data unit (PDU) set handling. The AUSF 214 can allow the AMF 216 to authenticate the UE and access services of the 5G core. The AMF 216 can perform operations like mobility management, registration management, connection management, UE-based authentication, etc. The SMF 218 can interact with the decoupled data plane, can perform internet protocol (IP) address allocation and management for UE devices (e.g., UE device 220), user plane selection, and packet routing in conjunction with the UPF 224, etc. The UPF 224 can perform user plane operations, such as maintaining protocol data unit (PDU) sessions, packet routing and forwarding, inspection policy enforcement for the user plane, Quality of Service (QoS) handling, providing data access to the UE 220, etc. A PDU session can provide connectivity between applications on the UE device 220 and the DN 226 (e.g., the Internet). The SMF 218 can also be responsible for creating, updating, and removing PDU sessions, selecting particular UPFs 224 on which to anchor PDU sessions when new UE devices 220 appear on the communication network, and managing session context with the UPF 224. Together with the UPF 224, the SMF 218 can maintain a record of PDU session state by means of a PDU Session ID.

The SBA 200 may also include a plurality service-based interfaces (SBIs) 228 to provide access to or communicate with the various NFs. As illustrated, such service-based interfaces may include an Nnssf interface for the NSSF 202, an Nnef interface for the NEF 204, an Nnrf interface for the NRF 206, an Npcf interface for the PCF 208, an Nudm interface for the UDM 210, an Naf interface for the AF 212, an Nausf interface for the AUSF 214, an Namf interface for the AMF 216, and an Nsmf interface for the SMF 218. In some embodiments, the UE 220 can communicate with the RAN 222 wirelessly, for example, via a radio transceiver 104 (shown in FIG. 1). The AMF 216 and the UE 220 can communicate signals or messages with another over, for example, an N1 interface. The AMF 216 and the RAN 222 can communicate signals or messages with one another over, for example, an N2 interface. The RAN 222 and the UPF 224 can communicate signals and data with one another over, for example, an N3 interface. The SMF 218 and the UPF 24 can communicate signals or messages with one another over, for example, an N4 interface. The UPF 224 can send and receive signals and data with the Internet 226 over an Internet interface, for example, an N6 interface. The AMF 216 and the SMF 218 can communicate signals and messages with one another over an interface, for example, an N11 interface.

The above-listed NFs and interfaces are intended to be illustrative and not exhaustive. In practical implementations, the SBA 200 may include additional NFs and other network entities, such as an SNPN Authentication and Authorization Function (NSSAAF), a Network Data Analytics Function (NWDAF), a United Data Repository (UDR), a 5G-Equipment Identity Register (5G-EIR), a Charging Function (CHF), a Service Communication Proxy (SCP), a Security Edge Protection Proxy (SEPP), a Hone Subscriber Service (HSS), a Home Location Register (HLR), a Binding Support Function (BSF), a Call Session Control Function (CSCF), a Session Border Control Function (SBC), a Media Resource Function (MRF), a Short Message Service Function (SMSF), or a Rich Communication Services Application (RCS).

As mentioned, in some embodiments, the communication network 100 (shown in FIG. 1) may be configured according to a region-based network topology. FIG. 3 is a schematic diagram of an example region-based network topology for a communication network in accordance with an embodiment. In some embodiments, the communication network (e.g., communication network 100 shown in FIG. 1) may be implemented using a cloud computing platform that is logically and physically divided up into various different cloud computing regions (e.g., AWS regions), for example, Region 1 (or a first national data center (NDC1) 302), Region 2 (or a second nation data center (NDC2) 304), and Region 3 (or a third national data center (NDC3) 306), as shown in FIG. 3. The cloud computing regions 302, 304, 306 may be based on the geographical location of the gNBs; for example, the communication network for a given nation may be divided into a number of geographical regions. Each of the cloud computing regions 302, 304, 306 can be isolated from other cloud computing regions to help provide fault tolerance, fail-over, load-balancing, and/or stability and each of the cloud computing regions can be composed of multiple availability zones or markets. For example, as illustrated in FIG. 3, the first region 302 includes a first availability zone 308 and a second availability zone 310, the second region 304 includes a fist availability zone 314 and a second availability zone 316, and the third region 306 includes a first availability zone 318 and a second availability zone 320. Each availability zone can be a separate data center (or datacenters) located in general proximity to each other (e.g., within 100 miles). For example, one cloud computing region may have its datacenters and hardware located in the northeast of the United States while another cloud computing region may have its data centers and hardware located in California. Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service. As mentioned, within an NDC 302, 304, 306, multiple regional data centers (RDCs) can be logically present. In FIG. 3, the first region 302 includes a first RDC 322, a second RDC 324, and a third RDC 326. The second region 304 includes a first RDC 328, a second RDC 330, and a third RDC 332. The third region includes a first RDC 334, a second RDC 336, and a third RDC 338. While three regions (or NDCs) 302, 304, 306. each including two availability zones, are illustrated in FIG. 3, it should be understood that, in some embodiments, a communication network may include fewer or more regions (or NDCs) and each region can include more than two availability zones. While each region 302, 304, 306 is shown with three RDCs in FIG. 3, it should be understood that, in some embodiments, a communication network may include fewer or more RDCs per region.

As mentioned, the network functions of the 5G core 108 (shown in FIG. 1 and SBA 200 in FIG. 2) can be distributed across data centers, for example, across the availability zones 308-320 of the national data centers 302, 304, 306 and/or the regional data centers 322-338. In the example illustrated in FIG. 3, network functions 312 can be associated with different availability zones 308-320 in the three regions 302, 304, 306 and can be executed by one or more of the regional data centers 322-338. Accordingly, there can be an instance of a particular type of network function in different regions, availability zones, and at different regional data centers within a region and availability zone. For example, an AMF network function may be logically deployed at each of the regional data centers 322, 324, 326 of the first region 302, logically deployed at each of the regional data centers 328, 330, 332 of the second region 304, and logically deployed at each of the regional data centers 334, 336, 338 of the third region 306. In another example, a PCF function may be logically deployed at a data center associated with each of the availability zones 308, 312 of the first region 302, logically deployed at a data center associated with each of the availability zones 314, 316 of the second region 304, and logically deployed at a data center associated with each of the availability zones 318, 320 of the third region 306.

In a communication network (e.g., a cellular network) such as communication network 100, if an end user (e.g., a subscriber that utilizes a particular UE in the communication network) has issues such as, for example, difficulty making or receiving calls, dropped calls, problems with other services, etc., an investigation may need to be performed into the issue to determine if a fault lies within the handling of communication sessions (e.g., a call or other service) within the communication network core (e.g., core 108 shown in FIG. 1). There are many places within the core 108 where a communication session (e.g., a call, messaging, data transmission, other services, etc.) could be dropped or negatively affected (e.g., at each network function or node). Call tracing allows data such as communications (e.g., signaling messages) between the cellular network core components (e, g., the network functions) to be gathered, output and analyzed.

Within a 5G core, call tracing can involve collecting communications between network functions that are part of, for example, a call flow. A call trace can be acquired using, for example, a probing solution (or cloud probing solution) that can be used to monitor and collect data for analysis and to troubleshoot the network functions of a communication network core. Currently available probing solutions, however, do not have the ability to determine and pinpoint the problematic network function(s) (or node(s)) in a call flow (i.e., a communication session flow) for a UE, and require manual human effort to analyze a call trace and identify the problem.

The present disclosure describes systems and methods for performing subscriber-based issue isolation in a communication network. In some embodiments, an issue isolation module may be provided that can be configured to identify one or more network functions that may be causing a network service issue for a particular UE/subscriber and to determine whether to remove the identified one or more network functions from rotation and redirect data traffic to, for example, a different instance of the network function(s) that provides the same services. In some embodiments, a processing database can be configured to receive subscriber call data for a plurality of UE's (e.g., collecting using one or more probes) of a communication network and to generate call detail records (CDRs) for each UE (and its associated subscriber) based on the collected subscriber call data. As used herein, the term “call” can refer to one or more of the various types of communication sessions supported by the communication network such as, for example, voice calls, video calls, messaging, data transmission, other types of communications, etc. The subscriber call data can include, for example, all of the traffic, packets, transactions, communications, etc. in the communication network for each UE. Each call detail record (CDR) for a UE (or subscriber) can be used to keep track of one of the transactions for the UE (or subscriber) and can include, for example, a date and time of the call (or communication session), a duration of the call, a subscriber identifier (e.g., a phone number, international mobile subscriber identity (IMSI), mobile subscriber ISDN number (MSISDN), etc.) of the UE, a location of the cell tower connected to the UE, the type of UE device used, the type of call, the cost of the call, the path of the call through the communication network (e.g., the specific network functions (or nodes) associated with the region of the UE device), other data relevant to the call, etc. Based on inputs received from an operator (or administrator), the issue isolation module can retrieve subscriber call data (e.g., CDR(s)) associated with a particular UE/subscriber from the processing database and then compare the acquired (or collected) subscriber call data for the subscriber to a set of predefined standardized call flows (e.g., stored in a standardized call flow database) for the communication network to identify problematic network functions. If a problematic network function is identified, the issue isolation module can be configured to determine whether to remove the identified network function from rotation (e.g., remove the identified instance of the network function from use for communication sessions). The issue isolation module can also remove the problematic network function from rotation and redirect data traffic in the communication network to, for example, a different instance of the particular network function in the communication network. Accordingly, the disclosed system and method can resolve subscriber related issues by automatically identifying and removing problematic network functions. In some embodiments, the disclosed system for performing subscriber-based issue isolation can also include a network analytics module configured to run analytics on the CDR's processed by the issue isolation module for the selected subscriber and create, for example, graphs, dashboards or trends that can be used, for example, in the determination of a problematic network function and how to resolve the problem. Advantageously, the disclosed system and method can reduce the overall troubleshooting time required to analyze a subscriber problem and enhance network management efficiency by swiftly identifying and isolating subscriber issues, thereby minimizing downtime and optimizing overall network performance. Accordingly, the disclosed system and method can provide advantages in cost effectiveness, speed of resolution and adaptability.

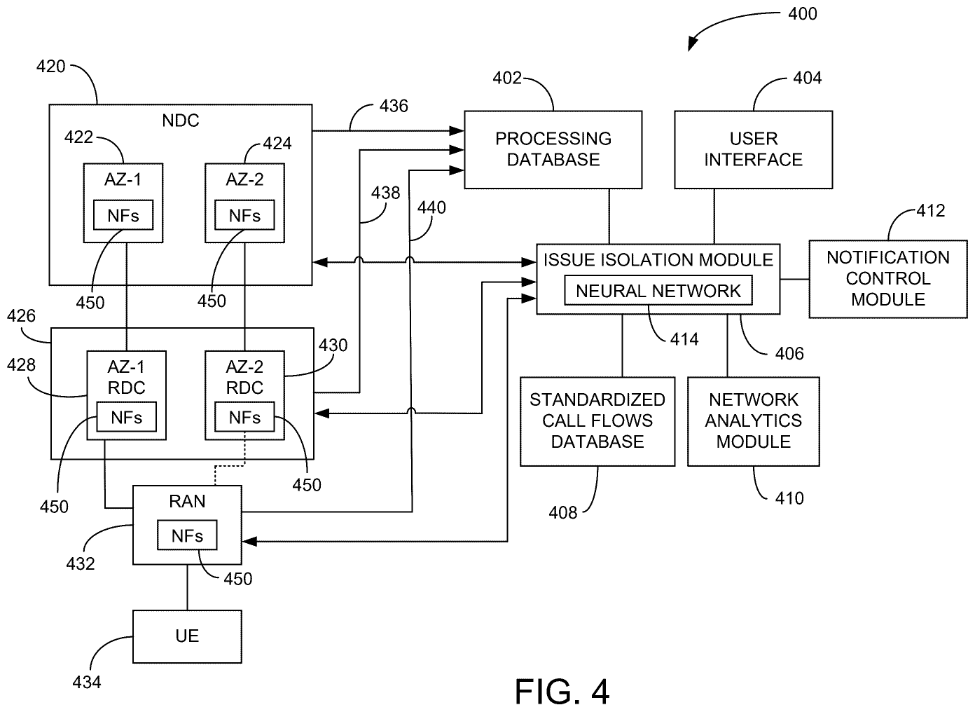

FIG. 4 is a schematic block diagram of a system for performing subscriber-based issue isolation in a communication network. The system 400 can include a processing database 402, a user interface 404, an issue isolation module 406, a standardized call flow database 408, a network analytics module 410, and a notification control module 412. The processing database 402 can receive subscriber call data for one or more UE's in a communication network (e.g., communication network 100 shown in FIG. 1). The subscriber call data can include, for example, all of the traffic, packets, transactions, communications (e.g., signal messaging), etc. for each UE that connects to and utilizes the communication network. In some embodiments, the subscriber call data can be collected from the communication network using probes (e.g., software probes) for various components of the communication network. For example, a first probe 436 can be used to collect and retrieve subscriber call data from a national data center 420, for example, from network functions 450 in the NDC 420. The national data center can include one or more availability zones, for example, a first availability zone 422 and a second availability zone 424, each of which can include instances of network functions (NFs) 450. A second probe 438 can be used to collect and retrieve subscriber call data from one or more regional data centers (RDCs) 426, for example, from network functions 450 in the RDCs 426. For example, in FIG. 4 a first RDC 428 is associated with the first availability zone 422 and a second regional data center 430 is associated with the second availability zone 424. Each RDC 428, 430 can include instances of network functions (NFs) 450. A third probe 440 can be used to collect and retrieve subscriber call data from a RAN 432 and the network functions (NFs) 450 associated with the RAN 432. While one NDC 420 (or region) is illustrated in FIG. 4, it should be understood that, in some embodiments, a communication network may include fewer or more NDCs (or regions), as described above with respect to FIG. 3. In some embodiments, the system 400 for subscriber-based issue isolation can be centralized and can be used for all regions (and the associated NDCs, RDCs, and RANs) in the communication network). In some embodiments, the system 400 for subscriber-based issue isolation can be distributed, for example, a separate system can be provided for each region (or NDC) in the communication network and the associated RDCs and RANs for the region. While the NDC 420 is illustrated with two availability zones 422, 424 and two RDCs 426, 430 and one RAN 432, it should be understood that in some embodiments, a communication network may include fewer or more availability zones and RDC's and more than one RAN 432.

In some embodiments, the subscriber call data collected for each UE that connects to the communication network can be collected continuously during the operation of the communication network. The processing database 402 can be configured to process the collected subscriber call data and to generate and store call detail records for each UE (and the associated subscriber). Each call detail record can be associated with one of the transactions of a particular UE (or subscriber). As mentioned, a call detail record for a particular transaction for a UE can include, for example, a date and time of the call, a duration of the call, a subscriber identifier (e.g., a phone number, international mobile subscriber identity (IMSI), mobile subscriber ISDN number (MSISDN), etc.) of the UE, a location of the cell tower connected to the UE, the type of UE device used, the type of call, the cost of the call, the path of the call through the communication network (e.g., the specific network functions (or nodes) associated with the region of the UE device), other data relevant to the call, etc.

The user interface 404 can be configured to allow an operator or administrator of a communication network (e.g., communication network 100 shown in FIG. 1) to provide inputs to the issue isolation module 406 and to display outputs from the issue isolation module 406. The user interface 404 (e.g., inputs 606 shown in FIG. 6) can include any suitable input devices and/or sensors that can be used to receive the user input, such as a keyboard, a mouse, a touchscreen a microphone, a graphical user interface (GUI), a voice user interface (VOI), mechanical switches, buttons, knobs, etc. The user interface can also include a display that can be used to display, for example, data generated by the issue isolation module 406 (discussed further below) to an operator or administrator of the communication network. The standardized call flows database 408 can be configured to store predefined standardized call flows for the communication network including but not limited to, for example, an initial registration call flow, a PDU session establishment call flow, IP Multimedia Services or Subsystems (IMS) related call flows (e.g. an IMS registration call flow), Short Messaging Service (SMS) related call flows, Voice Over WiFi (VoWIFI) related call flows, etc.

The issue isolation module 406 can be coupled to and in communication with the processing database 402, the user interface 404, and the standardized call flows database 408. The issue isolation module 406 can be configured to receive an input from the user interface 404 including a subscriber identifier for a particular UE in the communication network. As mentioned, the input can be provided from an operator or administrator via the user interface 404. For example, in FIG. 4, an operator may provide a subscriber identifier for a UE 434 connected to the network (e.g., via RAN 432) and for which an issue or problem with communication session(s) (or call(s)) has been reported and the administrator has been tasked with investigating the issue for the UE device 434. The subscriber identifier can be, for example, a phone number, international mobile subscriber identity (IMSI), mobile subscriber ISDN number (MSISDN), etc. In some embodiments, the input provided by the administrator can optionally also include issue data associated with the reported problem, for example, a data and time the issue occurred. Based on the subscriber identifier and, in some embodiments, issue data, the issue isolation module 406 can retrieve or fetch the subscriber call data (e.g., the raw data or the call detail records) associated with the subscriber identifier from the processing database 402. In some embodiments, if issue data is also provided, the issue data (e.g., a date and time the issue was reported) can be used to limit or filter the subscriber call data for the subscriber identifier that is retrieved from the processing database 402 by the issue isolation module 406 for analysis. In some embodiments, the issue isolation module 406 can be configured to identify one or more network functions (or nodes) that may be causing the reported network issue (e.g., a problem with a communication session) inside the call flow for the UE 434 (associated with the input subscriber identifier) by comparing the subscriber call data associated with the input subscriber identifier with the predefined standardized call flows from the standardized call flows database 408. In some embodiments, the issue isolation module 406 may include a neural network 414 that can be trained to compare the subscriber call data for input subscriber identifier to the standardized call flows to identify or determine one or more network functions that may be causing the reported issue. In some embodiments, the neural network 414 can be trained using training data that includes the predefined standardized call flows 408. In some embodiments, the neural network 414 can be fine-tuned with additional training to add additional types of standardized call flows (e.g., if there is a change in the architecture of the NDC 420, RDCs 426, and RAN 432).

The neural network 414 can be implemented as a machine learning model such as, for example, decision tree learning, association rule learning, an artificial neural network (e.g., a convolutional neural network (CNN), a generative adversarial neural network (GAN)). inductive logic programming, support vector machine, clustering, Bayesian network, reinforcement learning, representative learning, similarity and metric learning, sparse dictionary learning, and genetic algorithms. The neural network 414 can be trained using known methods such as supervised learning, backpropagation, self-supervised learning, semi-supervised learning, etc. As one example, to perform supervised learning, the training data include example inputs and corresponding desired (for example, actual) outputs and the neural network progressively develops a model that maps the inputs to the outputs included in the training data. As another example, to perform self-supervised learning, a neural network is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data).

The issue isolation module 406 may also be configured to automatically determine whether to take the one or more network functions that have been identified as problematic out of rotation (e.g., remove the identified instance of the network function from use for communication sessions). For example, in some embodiments, based on predetermined thresholds (e.g., related to performance) for the identified network function(s) the issue isolation module can determine that the identified network functions(s) should be removed from rotation and the data traffic redirected to a different instance of the same type of network function offering the same services in the region of the communication network (e.g., in the NDC 420, RDC 428 04 420, or the RAN 432) in which the UE 434 is located. In some embodiments, the data traffic can be redirected to a different type of network function offering the same service(s) in the region in which the UE 434 is located. In some embodiments, the issue isolation module 406 can be configured to automatically communicate with the NDC 420, RDC 426, and RAN 432 (e.g., via signal messaging) to provide commands or instructions to remove the identified problematic network function(s) out of rotation and redirect the data traffic. In some embodiments, the issue isolation module 406 can provide information or generate a report regarding the identified problematic network function(s) to the user interface (e.g., a GUI) to be displayed to an operator or administrator. For example, the user interface can be configured to display and highlight the procedure or step where the call flow for the UE 434 has broken and highlight the problematic network function(s).

In some embodiments, the issue isolation module 406 can provide the subscriber call data (e.g., CDRs) for the input subscriber identifier that were analyzed by the issue isolation module 406 to the network analytics module 410. In some embodiments, the network analytics module 410 can be configured to create or generate (e.g., by running analytics) analytics data such as, for example, graphs (e.g., statistical graphs) or trends, or dashboards (e.g., for key performance indicators) based on the subscriber call data for the input subscriber identifier processed by the issue isolation module 406. In some embodiments, the analytics data can be used by the issue isolation module 406 to, for example, determine whether an identified network function should be taken out of rotation. For example, if the issue experienced by the UE 434 occurs during peak hours, the problem may be caused by the number of users rather than an issue with the identified network function. Accordingly, in this example, the identified network function may not need to be taken out of rotation.

In some embodiments, the issue isolation module 406 may also be coupled to and in communication with the notification control module 412. The notification control module 412 can be configured to generate and transmit notifications regarding problems detected in the communication network by the issue isolation module 406. In some embodiments, the detected problems may be communicated via, for example, email or SMS messages. The notification(s) can be transmitted to, for example, a team at a network operation center (NOC) and/or to the end user (e.g., a subscriber) of the UE 434 to, for example, identify a potential outage/service downtime.

In some embodiment, the processing database 402, user interface 404, issue isolation module 406 (including, in some embodiments, neural network 414), standardized call flows database 408, network analytics module 410, and notification control module 412 may be implemented on a computer system (e.g., computer system 600 discussed below with respect to FIG. 6) such as a server. In some embodiments, the functionality of processing database 402, user interface 404, issue isolation module 406 (including, in some embodiments, neural network 414), standardized call flows database 408, network analytics module 410, and notification control module 412 may be distributed among multiple servers or devices (e.g., as part of a cloud computing environment).

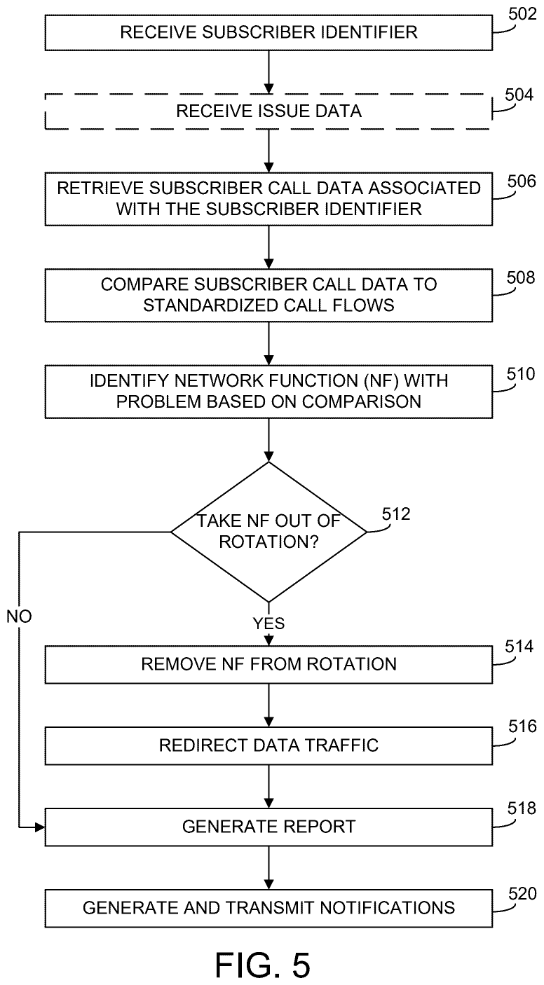

FIG. 5 illustrates a method for performing subscriber-based issue isolation in a communication network in accordance with an embodiment. The process illustrated in FIG. 5 is described as being carried out by the system illustrated in FIG. 4. However, in some examples, the process of FIG. 5 may be implemented by another system. Although the blocks of the process are illustrated in a particular order, in some embodiments, one or more blocks may be executed in a different order than illustrated in FIG. 5, or may be bypassed.

At block 502, a subscriber identifier can be received, for example, a subscriber identifier for a particular UE 434 in a communication network for which a problem or issue with a communication session (or call) has been reported. In some embodiments, an operator or administrator of the communication network (e.g., communication network 100) can provide the subscriber identifier as an input using a user interface 404 (e.g., a graphical user interface). As mentioned above, the subscriber identifier can be, for example, a phone number, international mobile subscriber identity (IMSI), mobile subscriber ISDN number (MSISDN), etc. At block 504, in some embodiments, issue data associated with the reported problem, for example, a data and time the problem occurred, may also be received. For example, an operator can provide the issue data as an input using the user interface 404. At block 506, subscriber call data associated with the subscriber identifier can be retrieved from a processing database 402 using, for example, an issue isolation module 406. The subscriber call data can include one or more call detail records for transactions of the UE 434 associated with the input subscriber identifier. As mentioned, a call detail record for a particular transaction for a UE can include, for example, a date and time of the call, a duration of the call, the subscriber identifier of the UE, a location of a cell tower connected to the UE, the type of UE device used, the type of call, the cost of the call, the path of the call through the communication network (e.g., the specific network functions (or nodes) associated with the region of the UE device), other data relevant to the call, etc. In some embodiments, if issue data is received at block 504, the issue data (e.g., a data and time the issue is reported) can be used to limit or filter the subscriber call data (associated with the subscriber identifier) that is retrieved from the processing database 402 by the issue isolation module 406 for analysis.

At block 508, the subscriber call data associated with the subscriber identifier can be compared (e.g., using an issue isolation module 406) to a set of predefined standardized call flows for the communication network, In some embodiments, the comparison can be performed using a trained neural network 414. At block 510, a network function (or more than one network function) can be identified (e.g., using an issue isolation module 406) that may be causing the reported issue based on the comparison of the subscriber call data associated with the subscribed identifier and the set of standardized call flows. At block 512, it can be determined (e.g., using an issue isolation module 406) whether the network function (or network functions) identified as problematic should be removed out of rotation. In some embodiments, the issue isolation module 406 can determine if the identified network functions(s) should be removed from rotation based on predetermined thresholds (e.g., related to performance) for the identified network function(s). As mentioned, in some embodiments, analytics data (e.g., generated by a network analytics module 410) can also be used by the issue isolation module 406 in the determination of whether an identified network function should be taken out of rotation. In some embodiments, the analytics data can be generated based on the subscriber call data (e.g., call detail records) retrieved block 506. As mentioned, the analytics data can include, for example, graphs (e.g., statistical graphs) or trends, or dashboards (e.g., for key performance indicators).

If, at block 512, it is determined that the network function(s) identified at block 510 should be removed out of rotation, at block 514, the identified network functions can be removed out of rotation. For example, in some embodiments, commands or instructions to remove the identified problematic network function(s) out of rotation can be automatically communicated (e.g., using the issue isolation module 406) with the NDC 420, RDC 426, and RAN 432 (e.g., via signal messaging). At block 516, data traffic can be redirected to a different network function in the communication network. In some embodiments, the data traffic can be redirected to a different instance of the same type of network function offering the same services in the region of the communication network (e.g., in the NDC 420, RDC 428 04 420, or the RAN 432) in which the UE 434 is located. In some embodiments, the data traffic can be redirected to a different type of network function offering the same service(s) in the region in which the UE 434 is located. Commands or instructions to redirect the data traffic can be automatically communicated (for example, using the issue isolation module 406) with the NDC 420, RDC 426, and RAN 432 (e.g., via signal messaging). If, at block 512, it is determined that the identified network function(s) should be removed out of rotation, the process can move to block 518.

At block 518, a report can be generated that includes, for example, information regarding the identified problematic network function(s). For example, the report can include the procedure or step where the call flow for the UE 434 has broken and the identified problematic network function(s). In some embodiments, the report can be provided to a user interface 404 (e.g., a GUI) to be displayed to an operator or administrator of the communication network. At block 520, notifications can be generated and transmitted (e.g., using a notification control module 412) to, for example, a team at a network operation center (NOC) and/or to the end user (e.g., a subscriber) of the UE 434 to, for example, identify a potential outage/service downtime. In some embodiments, the notifications can include information regarding the problems detected in the communication network by the issue isolation module 406. In some embodiments, the notifications may be communicated via, for example, email or SMS messages. As mentioned, the notification(s) can be transmitted to, for example, a team at a network operation center (NOC) and/or to the end user (e.g., a subscriber) of the UE 434.

As mentioned above, various components of the disclosed system and method may be implemented on a computer system. FIG. 6 is a schematic block diagram of an example computer system in accordance with an embodiment. The computer system 600 (e.g., a server) may include one or more processor devices 602, a display 604, one or more inputs 606, one or more communication systems 608, and memory 610. In some embodiments, processor device(s) 602 can be any suitable hardware processor or combination of processors, such as a central processing unit (CPU), a graphics processing unit (GPU), a microprocessor, an application specific integrated circuit (ASIC), field programmable gate arrays (FPGA), digital signal processors (DSPs), etc. The processor device(s) 602 may include one or more processors, processor cores, processing elements, processor clusters, or other electronic processing units. Accordingly, a processing function described as being performed by the processor device(s) 602 may include multiple processors, processor cores, processing elements, processing clusters, etc. (of the processor device(s) 602) performing aspects or portions (sub-functions) of the processing function to complete the processing function. The one or more electronic processing units of the processor device(s) 602 may include one or more microprocessors, application-specific integrated circuits (“ASICs”), or other suitable electronic device for processing data. At least in some examples, the one or more electronic processing units of the processor device(s) 602 can be co-located physically (e.g., in the same facility, building, room, rack, or computing housing) as part of the computer system 600.

In some embodiments, display 604 can include any suitable display devices, such as a computer monitor, a touchscreen, a television, etc. In some embodiments, display 604 can be omitted. In some embodiments, inputs 606 can include any suitable input devices and/or sensors that can be used to receive user input, such as a keyboard, a mouse, a touchscreen, a microphone, a graphical user interface (GUI), a voice user interface (VOI), mechanical switches, buttons, knobs, etc. and allow a user or operator to interact with the system for sentiment analysis. In some embodiments, inputs 606 can be omitted.

In some embodiments, communications system(s) 608 can include any suitable hardware, firmware, and/or software for communicating information over any suitable communication network (e.g., communication network 100 shown in FIG. 1). For example, communication system(s) 608 can include one or more transceivers, one or more communication chips and/or chip sets, etc. In a more particular example, communication system(s) 608 can include hardware, firmware and/or software that can be used to establish a Wi-Fi connection, a Bluetooth connection, a cellular connection an Ethernet connection, etc.

In some embodiments, memory 610 can include any suitable storage device or devices (e.g., one or more non-transitory computer readable media) that can be used to store instructions, values, etc., that can be used, for example, by processor device 602 to present content using display 604, to communicate with a communication network, to communicate with other computer systems, etc. Memory 610 can include any suitable volatile memory, non-volatile memory, storage, or any suitable combination thereof. For example, memory 610 can include RAM, ROM, EEPROM, one or more flash drives, one or more hard disks, one or more solid state drives, one or more optical drives, etc. The memory 610 may store data and/or instructions for use and execution by the computer system 600 (e.g., by the processor device(s) 602) to implement the functionality of, for example, the processing database, the user interface, the issue isolation module, the network analytics module, the notification control module, the neural network 414, etc. described herein. For example, the memory 610 may include or store the processing database 402, the user interface 404, the issue isolation module 406, the standardized call flow database 408, the network analytics module 410, the notification control module 412, and the neural network 414 shown in FIG. 4, respectively. In some embodiments, the functionality described herein as being performed by the computer system 600 may be distributed among multiple computer systems, servers or devices (e.g., as part of a cloud service or cloud-computing environment).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodies on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on. As specific examples, a control device can include a processor, a microcontroller, a field-programmable gate array, a programmable logic controller, logic gates, etc., and other types of components that are known in the art for implementation of appropriate functionality (e.g., memory, communication systems, power sources, user interfaces, and other inputs, etc.).

Certain operations of the methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A system for performing subscriber-based issue isolation in a communication network, the system comprising:
a processing database comprising subscriber call data associated with a plurality of user equipment devices in the communication network;
a user interface configured to receive a subscriber identifier associated with a user equipment device of the plurality of user equipment devices having a reported problem with a communication session over the communication network;
a standardized call flow database comprising a set of predefined standardized call flows for the communication network; and
an issue isolation module coupled to an in communication with the processing database, the user interface, and the standardized call flow database, the issue isolation module configured to identify at least one network function in the communication network associated with the reported problem by comparing subscriber call data associated with the subscriber identifier to the set of predefined standardized call flows, and to remove the identified at least one network function out of rotation in the communication network.

2. The system according to claim 1, wherein the issue isolation module comprises a neural network configured to compare the subscriber call data associated with the subscriber identifier and the set of predefined standardized call flows.

3. The system according to claim 1, wherein the issue isolation module is further configured to generate commands to redirect data traffic from the identified at least one network function to a different instance of the identified at least one network function in the communication network.

4. The system according to claim 1, further comprising a notification control module coupled to and in communication with the issue isolation module and configured to generate a notification based on the identified at least one network function and the reported problem.

5. The system according to claim 1, wherein the user interface comprising a graphical user interface.

6. The system according to claim 1, further comprising a network analytics module coupled to and in communication with the issue isolation module and configured to process the subscriber call data associated with the subscriber identifier to generate analytics data.

7. The system according to claim 1, wherein the subscriber call data comprises call detail records.

8. A method for performing subscriber-based issue isolation in a communication network having a plurality of user equipment devices, the method comprising:
receiving a subscriber identifier associated with a user equipment device of the plurality of user equipment devices having a reported problem with a communication session over the communication network;
retrieving, using an issue isolation module, subscriber call data associated with the subscriber identifier;
comparing, using the issue isolation module, the subscriber call data to a set of predefined standardized call flows for the communication network;
identifying, using the issue isolation module, at least one network function in the communication network associated with the reported problem; and
removing, using the issue isolation module, the identified at least one network function out of rotation in the communication network.

9. The method according to claim 8, further comprising generating, using the issue isolation module, commands to redirect data traffic from the identified at least one network function to a different instance of the identified at least one network function in the communication network.

10. The method according to claim 9, further comprising transmitting, using the issue isolation module, the commands to redirect data traffic to one or more components of the communication network.

11. The method according to claim 8, further comprising processing, using a network analytics module, the subscriber call data associated with the subscriber identifier to generate analytics data.

12. The method according to claim 8, further comprising generating, using a notification control module, a notification based on the identified at least one network function and the reported problem.

13. The method according to claim 8, wherein the subscriber call data comprises call detail records.

14. The method according to claim 8, further comprising displaying, using a graphical user interface, the identified at least one network function in the communication network associated with the reported problem.

15. A non-transitory, computer-readable medium storing instructions that, when executed by an electronic processor, perform a set of functions for performing subscriber-based issue isolation in a communication network, the set of functions comprising:
receiving a subscriber identifier associated with a user equipment device having a reported problem with a communication session over the communication network;
retrieving subscriber call data associated with the subscriber identifier,
comparing the subscriber call data to a set of predefined standardized call flows for the communication network;
identifying at least one network function in the communication network associated with the reported problem; and
removing the identified at least one network function out of rotation in the communication network.

16. The non-transitory, computer-readable medium according to claim 15, wherein the set of functions further comprises further comprising generating commands to redirect data traffic from the identified at least one network function to a different instance of the identified at least one network function in the communication network.

17. The non-transitory, computer-readable medium according to claim 16, wherein the set of functions further comprises transmitting the commands to redirect data traffic to one or more components of the communication network.

18. The non-transitory, computer-readable medium according to claim 15, wherein the set of functions further comprises processing the subscriber call data associated with the subscriber identifier to generate analytics data.

19. The non-transitory, computer-readable medium according to claim 15, wherein the set of functions further comprises generating a notification based on the identified at least one network function and the reported problem.

20. The non-transitory, computer-readable medium according to claim 15, wherein the subscriber call data comprises call detail records.
